(19) United States
(12) Patent Application Publication
(10) Pub. No.: US 2018/0211056 A1
(43) Pub. Date: Jul. 26, 2018

(54) SYSTEMS AND METHODS FOR SCOPE-BASED ACCESS

(71) Applicant: AUTHSCOPE, INC., LAKE FOREST, CA (US)

(72) Inventor: Wayne Delisser, Lake Forest, CA (US)

(21) Appl. No.: 15/489,597

(22) Filed: Apr. 17, 2017

Related U.S. Application Data
(60) Provisional application No. 62/323,470, filed on Apr. 15, 2016.

(51) Int. Cl. G06F 21/62; H04L 29/06; G06F 21/60

(52) U.S. Cl. CPC G06F 21/6218; H04L 63/101; H04L 63/102; G06F 17/30958; H04L 63/20; G06F 2221/2141; G06F 21/604

(57) ABSTRACT

An authorization system provides fine grain entitlements to a resource server by retrieving a dynamic constraint graph as a function of an authorization request, and traversing the dynamic constraint graph as a function of the contextual attributes of the request. The contextual attributes can include local contextual attributes specific to the user or user group, and global contextual attributes specific to the current environment of the authorization system. Traversing the dynamic constraint graph provides an access result that can provide fine grain entitlements for a request.

### FIELD OF THE INVENTION

The present invention relates to security in computer systems. More particularly, the invention relates to control of the access of users/devices to objects protected by OAuth 2.0 authorization framework.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Authentication frameworks are essential for providing proper access to data storage. For example, U.S. Pat. No. 7,480,299 to O'Keefe et al. teaches a rules engine with an access control list table that define an access control list rule, an action, and a chain identifier. When a packet arrives, the rules engine searches the access control list table for a match, and forwards the packet to the authorized address in accordance with the action. O'Keefe's rules engine, however, fails to take into consideration contextual information which can change over time.

U.S. Pat. No. 7,650,644 to Cheng teaches a permission data object that identifies a group affiliation associated with a user and a business object time to which the permission object controls access. If a user of Cheng's system changes group affiliation, the access level of the user could change as well. Cheng's system, however, fails to take into account that users can have several attributes that could affect a user's access level, and not just a group affiliation.

U.S. Pat. No. 9,514,286 to Forster teaches a computer program that evaluates a context-based policy that provides access based on a context containing attributes about the request itself. Forster's computer program generates a tree by identifying a frequency of occurrence of a set of attribute values, sorts the attribute values based upon the frequency occurrence, and constructs a weighted index tree with normalized rulesets. Forster's tree can then be traversed to provide authentication without requiring certain attributes to be explicitly indexed. Forster's tree, however, needs to be periodically regenerated when attribute value frequencies change, and isn't easily manipulated or editable by users who wish to control system access to sensitive data storage.

Thus, there remains a need for a system and method to control the scope of access that responds to a request for access.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

The inventive subject matter provides apparatus, systems, and methods that enables users and devices to carry out a wide range of authorized tasks by dynamically regulating their actions according to flexible functions, relationships, and constraints to provide fine grain entitlements via scope-based access control (SBAC). SBAC regulates access to Representational State Transfer (REST) application program interfaces (APIs) allowing additional dynamic constraints to be added at evaluation time.

Typically, a resource server will send an authorization evaluation request to the system. Each authorization request typically comprises one or more of the following: a requested resource (e.g. /orders or /trade), one or more scopes (e.g. place_order or transfer_trade), a set of local contextual attributes, a set of global contextual attributes, and an action (e.g. GET, POST). Generally, the authorization request comprises at least a requested resource and a scope. As used herein, “local contextual attributes” comprise attributes specific to an instance or a user (e.g. user identifier, user role, assignments rights, location of client computer). As used herein, “global contextual attributes” comprise attributes that are applicable to all users of the system (e.g. time of day, current state in a state machine, system logs). Local and global contextual attributes need not be sent by the resource server, and could be received from alternative sources (e.g. another resource server, a database, the system clock).

The system retrieves a dynamic constraint graph from a catalog as a function of one or more of the aforementioned components, for example as a function of the requested resource and scope, or as a function of the requested resource and action. As used herein, a “dynamic constraint graph” comprises a flowchart of nodes of security checks which direct a navigating entity down a variety of paths. Exemplary graphs include binary trees, trinary trees, and other variations of decision trees that lead the system towards an access result. Simple graphs include only grant paths and deny paths. As a navigating entity traverses a dynamic constraint path, the navigating entity eventually reaches an access result. Security checks could decide whether to traverse a path as a function of any of the local and/or global contextual attributes. In some embodiments, the system could flatten the dynamic constraint graph into an access control list (ACL) format to speed up the time to process an authorization request. Such an ACL could have keys for each permutation of available contextual attributes that are each correlated with an access result.

Since traditional resource servers only transmit basic requests that don't contain contextual information, the system could provide a plugin to resource servers that allow the resource server to properly form authorization evaluation requests that contain contextual attributes. Such plugin would then transmit the authorization evaluation request to a SBAC system and provide the authorization result to resource server. Such plugins would extend the resource server's ability to allow an application to gain access to a service, in addition to the system's context-sensitive dynamic constraint graphs, which allow the system to determine whether a requesting server should be granted access to a service based upon the additional sent context information. Providing context-sensitive dynamic constraint graphs allow the system to provide fine grained scope-based access control.

It is therefore an object of the invention to provide a method of defining scopes to reflect enterprise security policies for controlling access of individuals and devices to objects.

It is a further object of the invention to provide a method whereby access of individuals and devices to objects controlled by an OAuth 2.0 compliant system can be extended using SBAC.

It is a further object of the invention to provide a method for employment of a SBAC system as an access layer for securing access to systems that leverage Representational State Transfer (REST) application program interfaces (APIs) as their interfaces for interaction.

Various objects, features, aspects and advantages of the inventive subject matter will become more apparent from the following detailed description of preferred embodiments, along with the accompanying drawing figures in which like numerals represent like components.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### BRIEF DESCRIPTION OF THE DRAWING

FIG. 1 shows an exemplary visual depiction of a scope.

FIG. 2 shows a structure of an exemplary dynamic constraint graph.

FIG. 3 shows an exemplary scope.

FIG. 4 shows an exemplary scope based access control.

FIG. 5 shows an exemplary scope authorization at runtime

FIG. 6 shows an exemplary dynamic constraint graph for a trade authorization request.

FIG. 7 shows an exemplary dynamic constraint graph for a heathcare device authorization request.

FIG. 8 shows an exemplary ACL table representation of the dynamic constraint graph of FIG. 6.

FIG. 9 shows an exemplary hardware configuration for a fine grain entitlement system.

### DETAILED DESCRIPTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. The term “functionally coupled to” could be used to refer to devices that are configured so as to communicate with one another electronically, for example through a Bluetooth or a Wi-Fi connection.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be noted that any language directed to a computer system should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The inventive subject matter provides apparatus, systems, and methods that enables users and devices to carry out a wide range of authorized tasks by dynamically regulating their actions according to flexible functions, relationships, and constraints to provide SBAC fine grain entitlements. SBAC enables users and devices to carry out a wide range of authorized tasks by dynamically regulating their actions according to flexible functions, relationships, and constraints. SBAC specifies and enforces enterprise-specific security policies with a set of high-level controls by using scopes to define and enforce enterprise-specific security policies. Using the current system, attributes, users, roles, groups, or any additional metadata in the form of transaction context can be injected into the authorization decision to augment the issued scope. This is in contrast to conventional methods of scope authorization, which grant or deny access based solely on the binary nature of having the string token or not.

Preferably, the SBAC system is implemented on an existing authorization framework, such as the OAuth 2.0 authorization framework, which enables a third-party application to obtain limited access to an HTTP service. The OAuth 2.0 authorization framework has an Internet Engineering Task Force (IETF) RFC 6749 that defines the use of an “Access token scope” as a parameter expressed as a list of space-delimited, case-sensitive strings. Once a scope is issued, it is static and cannot be modified. Existing frameworks such as the OAuth 2.0 authorization framework, however, fail to take into consideration contextual attributes that can be received or polled by an authorization system to improve entitlements granted to a user.

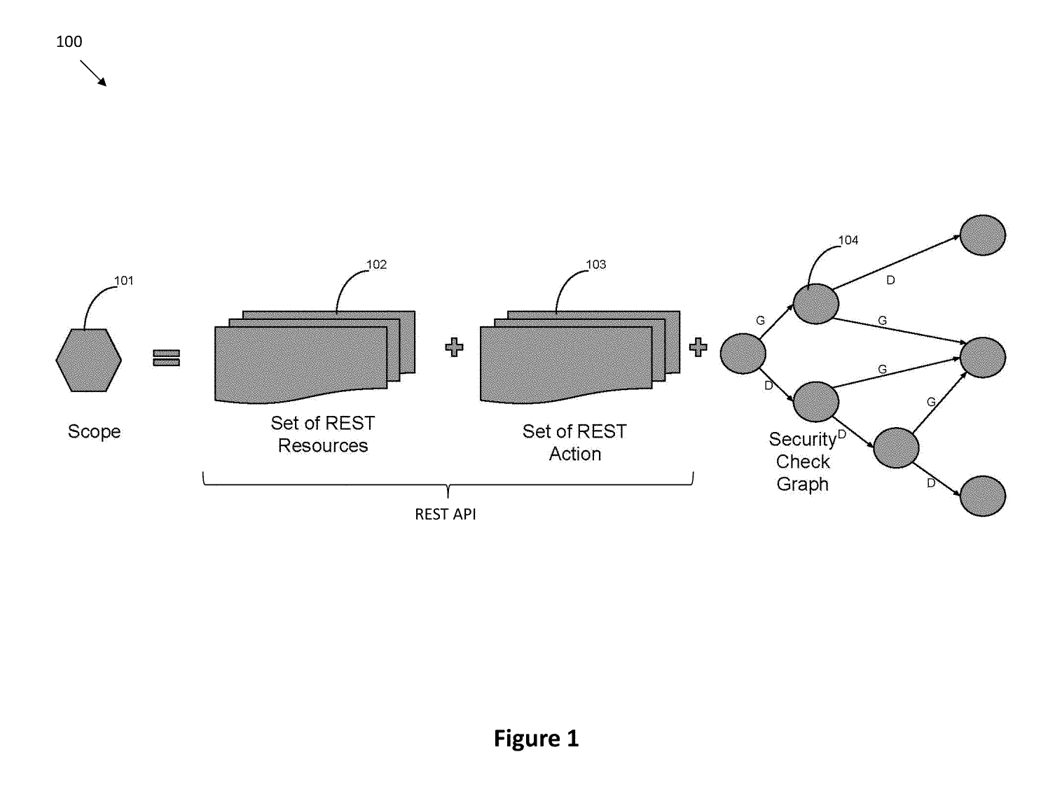

FIG. 1 shows an exemplary visual depiction 100 of a scope 101 that is defined by traversing a dynamic constraint graph 104 via a REST API, which here comprises a set of REST resources 102 and a set of REST actions 103.

REST resources 102 are resources that are available to a user for accessing via one or more REST actions 103. Typical REST actions include, for example, HTTP verbs, such as GET, POST, PUT, DELETE, PATCH, etc., but could be actions via any other network-based protocol that allows a remote user to access resources on a resource server. Dynamic constraint graph 104 comprises a traversable tree structure that enables the system to determine the type of access result that is appropriate for a given authorization request.

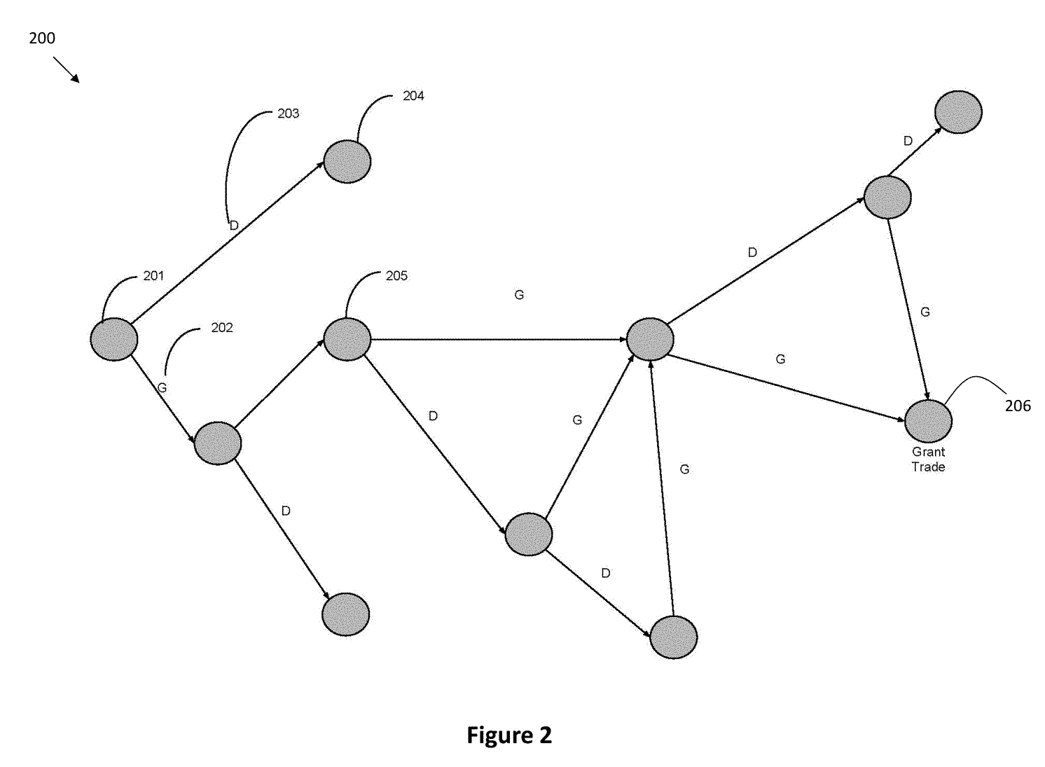

FIG. 2 shows an exemplary dynamic constraint graph 200 having a plurality of nodes 201 and 205, and edges 202 and 203, where each node comprises a security check, and each edge comprises a one-way decision tree flow, shown here as binary grant flow 202 and deny flow 203. Each node of dynamic constraint graph 200 represents an atomic block that, when evaluated, results in a grant flow 202 or a deny flow 203. In other embodiments, a security check graph could have 3, 4, or more edges that lead from a security check, which are traversed as a function of contextual attributes associated with the authorization request. Each leaf in the dynamic constraint graph 200, such as leaf 204, represents a final grant/deny access result. In dynamic constraint graph 200, leaf 204 represents an exemplary deny access result, while leaf 206 represents a grant access result. The entirety of dynamic constraint graph 200 defines an enterprise security policy for an authorization request.

The system traverses the graph using received contextual attributes to generate an access result. At each decision node, the system uses one or more of the contextual attributes to navigate the dynamic constraint graph until, eventually, an access result is obtained. The system could send a reply transmission to the resource server as a function of the access result, for example a granting of access and a denial of access. In some embodiments, the reply transmission could include more than just a mere grant or denial of access, such as an obligation. For example, a grant access result could include an obligation that constrains the access result in some manner (e.g. a period of time wherein the grant is active for that user, or a period of time wherein the denial is active for that user). A denial access result could include an obligation that reports an error code for denying access. In other embodiments, the reply transmission could include an alternative resource or an alternative scope other than the resource and/or scope that the resource server was requesting. For example, a resource server might request access to a primary database that the requestor does not have the rights to access, but the system could transmit access to a secondary database that the requestor does have the rights to access. Preferably the resource server is identified in the dynamic constraint graph, but in some embodiments the dynamic constraint graph could fetch a secondary database as a function of the access result.

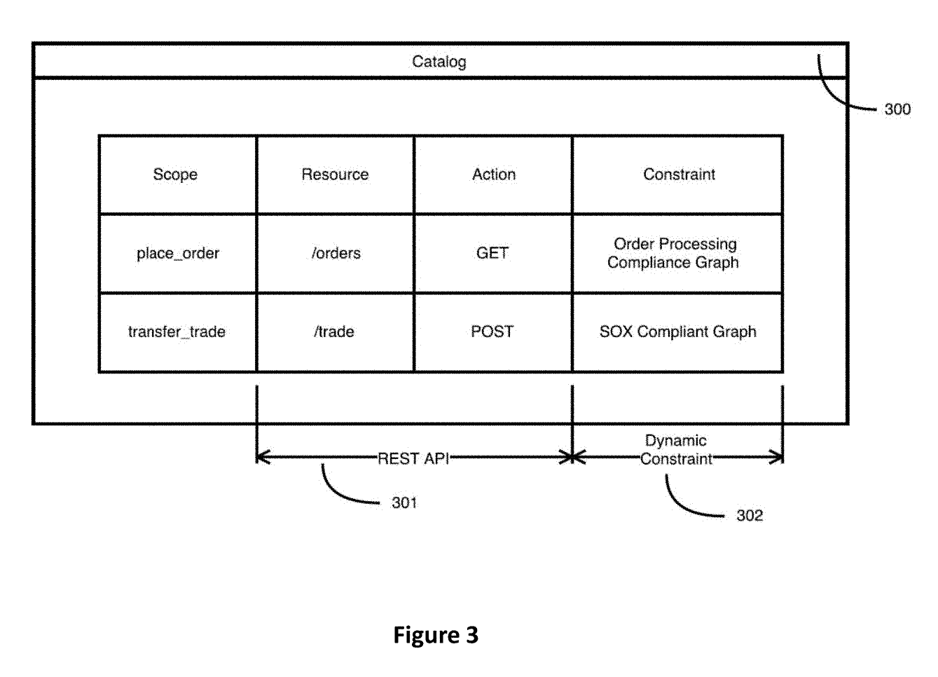

FIG. 3 shows an exemplary scope catalog 300 that comprises scope to REST API mappings 301 and correlates them with dynamic constraint graphs 302. Scope catalog 300 comprises the security policies for an enterprise, and can be used to correlate a plurality of dynamic constraint graphs that can be used to control access by providing access results as a function of the contextual attributes of an authorization request. Here, each dynamic constraint graph is correlated with a scope, a resource, and an action, however scope catalogs could correlate a dynamic constraint graph with other portions of an authorization request if need be. Here, if a resource server submits a GET request for the resource “/orders,” the system could review catalog 300 and determine that the system needs to traverse the “Order Processing Compliance Graph” as a function of the contextual attributes of the authorization request. Should the request be granted, the scope “place_order” could be provided as a part of the access result for the authorization request.

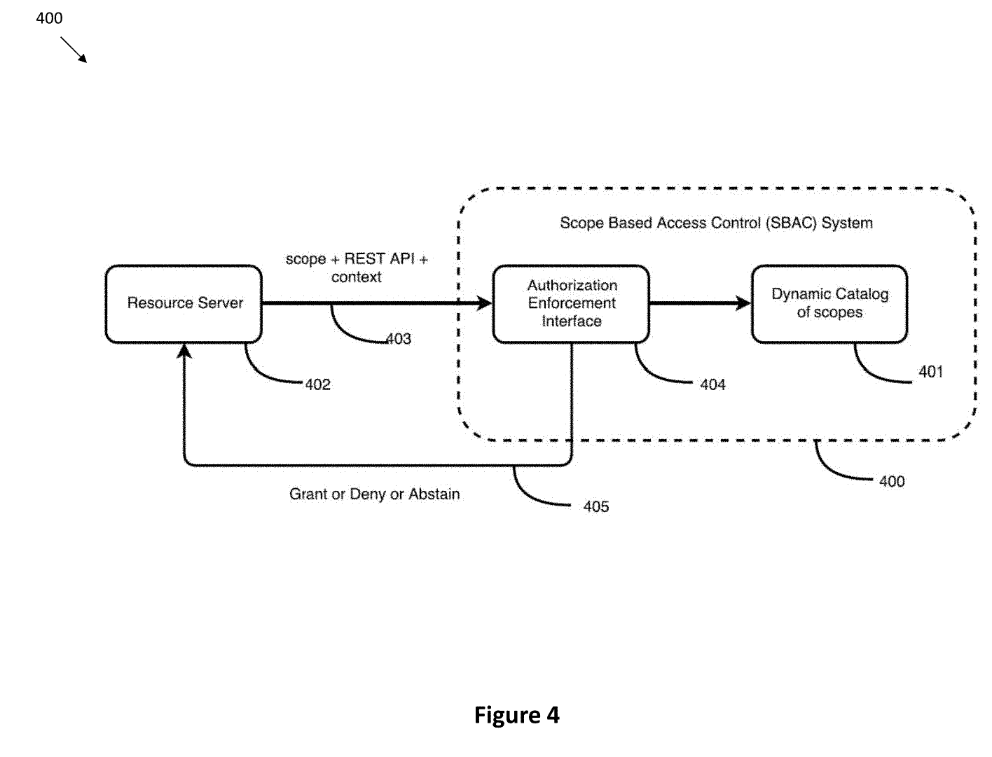

FIG. 4 shows an exemplary software schematic of an SBAC system 400 that communicates with a resource server 402. Resource server 402 submits an authorization request 403, which in this embodiment comprises a requested scope, a REST API, and contextual attributes. Authorization enforcement interface 404 receives the requested scope and REST API, and reviews the dynamic catalog of scopes 401 to retrieve a dynamic constraint graph as a function of the REST API and the scope. The authorization enforcement interface 404 then traverses the dynamic constraint graph as a function of the contextual attributes and provides an access result decision 405, which here is represented by a grant, deny, or abstain decision. Preferably, communications between resource server 402 and authorization enforcement interface 404 are handled via REST-based services.

Embodiments disclosed herein provide descriptions of actions taken by an evaluation engine for runtime authorization evaluation of a scope. SBAC system 400 has access to all scope based policies 401 that are preferably pre-created and stored in a database for an application that resides in the scope catalog.

SBAC system 400 can preferably new policies and update or delete existing ones via a deployment mechanism or another user interface, such as an administrator user interface. In another embodiment, a reusable scope based policy could be deployed so that one policy can be used to make different authorization decisions. Elements within the dynamic constraint graph could be parameterized so that the system dynamically constructs new policies as a function of input data parameters and a request posture. For example, a new input data parameter could trigger the authorization enforcement interface 404 to search for that input data parameter in an automatic template updater (not shown), which could then trigger that input data parameter to be added as a decision node to a set of relevant dynamic constraint graphs.

While the present embodiment shows resource server 402 providing the contextual attributes used to traverse the dynamic constraint graph with the authorization request, SBAC system 400 could receive the contextual attributes in a variety of ways. For example, SBAC system 400 could poll other devices to retrieve global contextual attributes, such as a system clock to determine the date/time or a database to determine threshold levels, or SBAC system 400 could poll resource server as a function of the retrieved dynamic constraint graph, as different graphs may require different contextual attributes to traverse it.

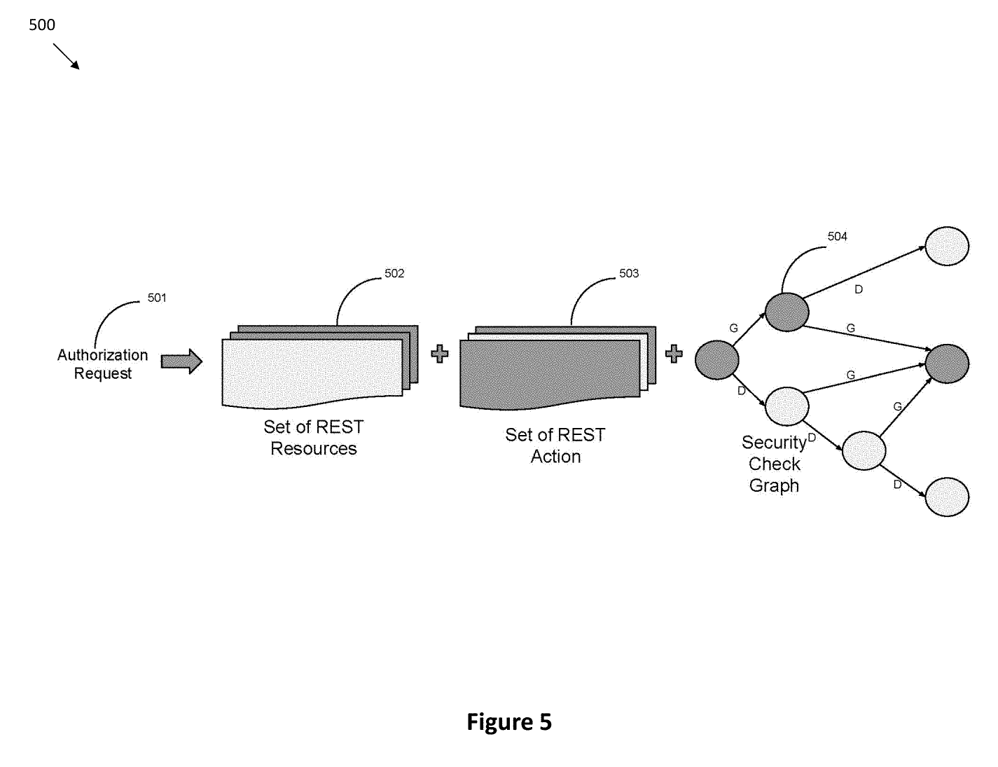

FIG. 5 shows a scope evaluation 500, where an authorization request 501 that triggers one or more policies. Each policy will start by identifying a particular resource from available/predefined set of HTTP resources 502, then identify an action from available/predefined set of REST actions 503 and lastly perform a particular well-defined computation as defined in the security checks graph 504. An example of such a computation can be extraction of information from request, transformation the data to fit operational needs (e.g., converting the request timestamp to evaluation engine time zone) and then an evaluation of expressions to calculate the result. The sum conclusion of each of the plurality of scope based policy evaluations, will result into the eventual authorization decision to be granted or denied.

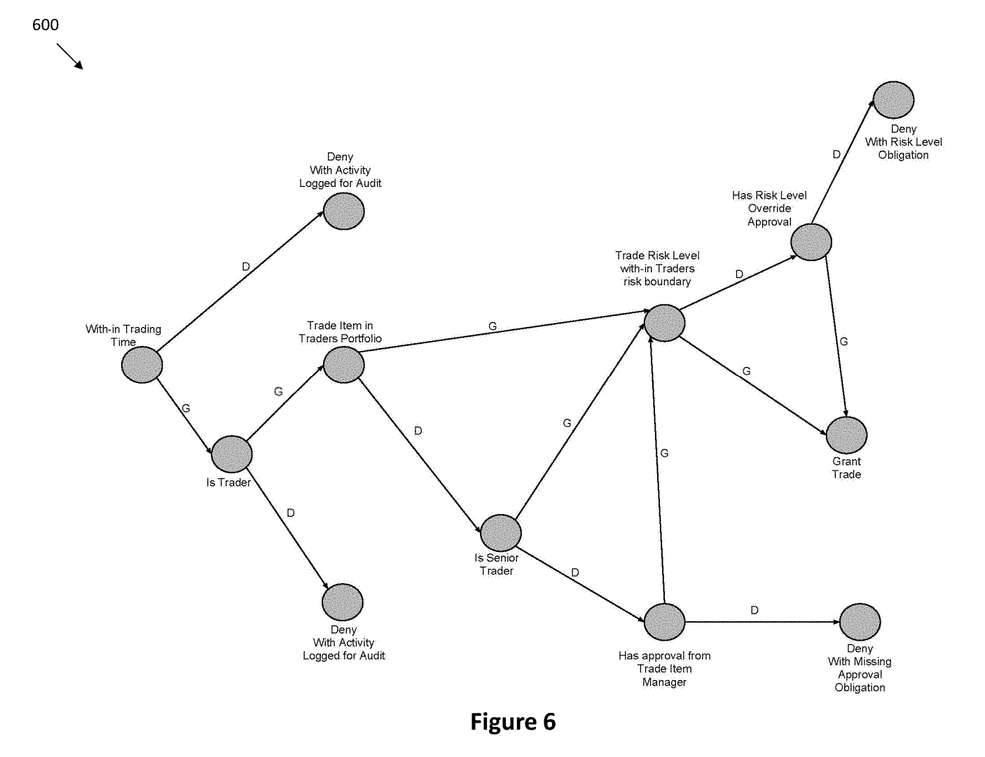

FIG. 6 shows an exemplary dynamic constraint graph 600 that regulates which trades should be allowed and which trades should be denied for an authorization request for a trade. This SBAC system will have scope based policy defined to enforce enterprise security checks around carrying out trading requests. Execution of this policy would result into one of the final actions—grant if all the security checks in the graph passed successfully; deny—if one or more security checks in the graph failed during execution. Each of the deny access results here also comprises an obligation that is enforced upon the user, such as an activity logged for audit (not visible to the user), a missing approval obligation (which is transmitted to the resource server to inform the user that the approval context is missing, or could be transmitted directly to a user interface itself), and a risk level obligation (which is transmitted to the resource server to inform the user that the risk level override approval is missing, or could be transmitted directly to a user interface itself).

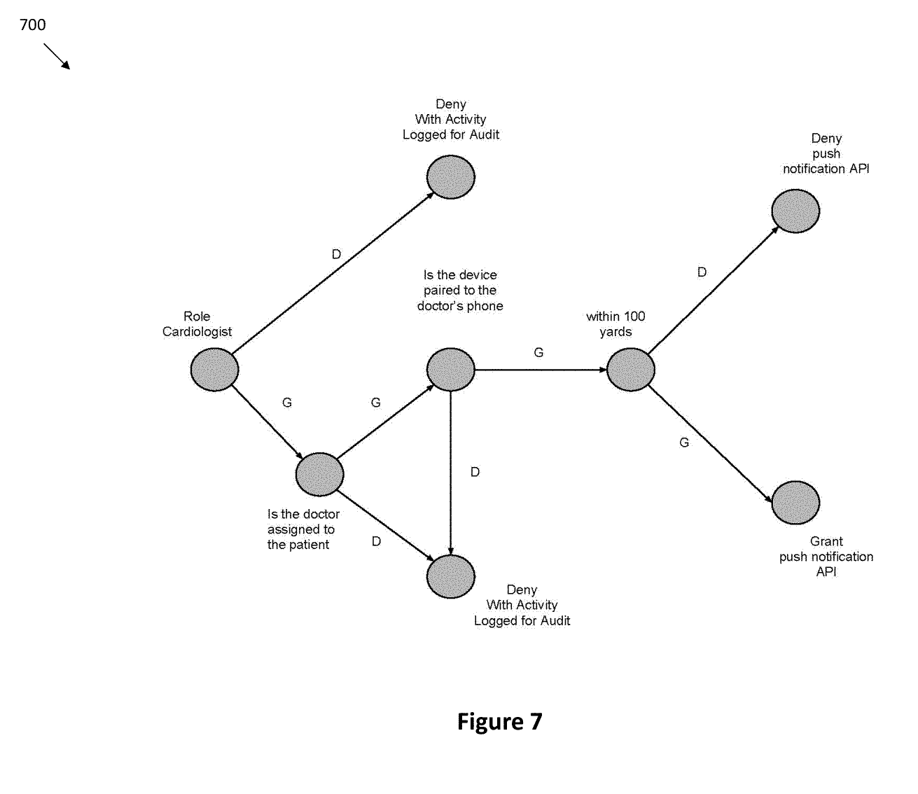

FIG. 7 shows another embodiment of the present invention, where an SBAC system is used to regulate authorization decisions of an Internet of Things (IoT) device—here the IoT device is a medical device. Here, the SBAC systems could scope based policies defined that leverage a “security checks” graph to take decisions based on a multitude of factors such as devices location, user role type, user location etc. Preferably, the SBAC system polls some contextual attributes from the resource server, and other contextual attributes from other systems, such as a database that reveals a user's role type as a function of a user ID, or a locator that reveals a user's location as a function of a device ID or a user ID. Dynamic constraint graph 700 is an example of a constraint graph that could be used to control access decisions related to health care devices. Here, the scope is a grant of a push notification API to the IoT device.

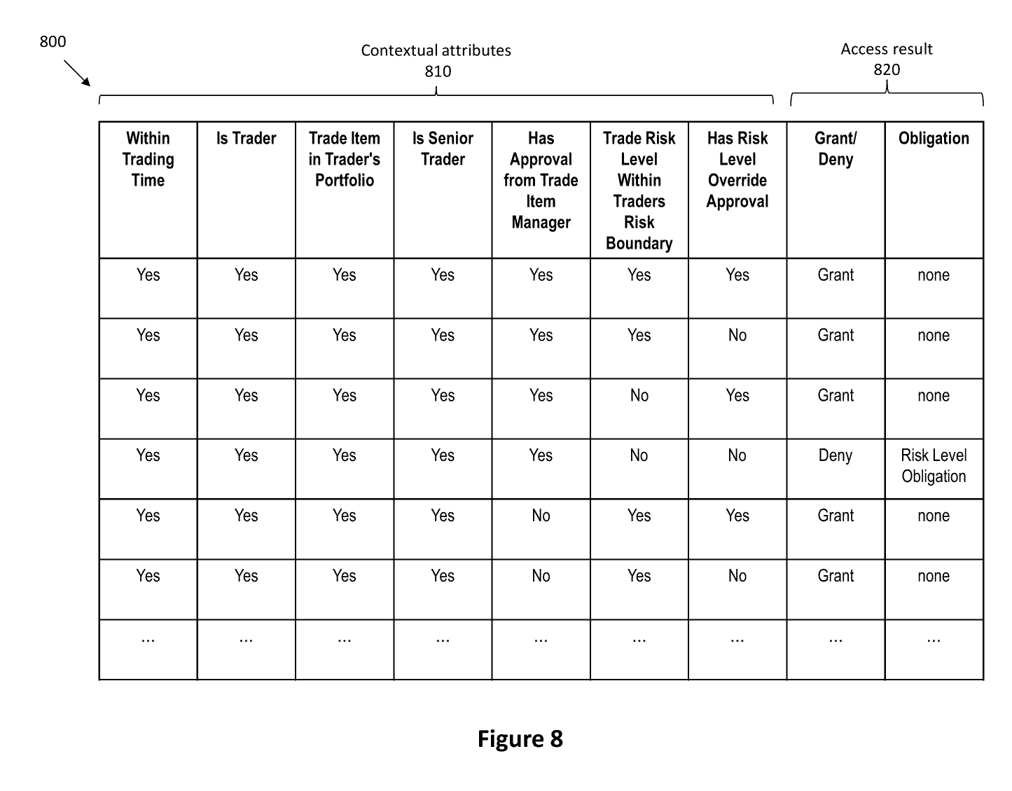

FIG. 8 shows an exemplary flattened access control list (ACL) representation 800 of dynamic constraint graph 700. The SBAC system could automatically generate a flattened ACL representation of a dynamic constraint graph 700 for use in legacy systems that only have the ability to look up grant/deny path using an ACL. Here, the SBAC system generated the flattened ACL representation by analyzing a graph and determining all contextual attributes evaluated by the graph, and then generates ACL table 800 with every permutation of all contextual attributes 810. Then, the SBAC system runs through the graph using every permutation to glean the appropriate access results 820, which here comprise an appropriate grant/deny response and the appropriate obligation that might be incurred upon the user. Generating such an ACL table is time-consuming, and such an ACL table needs to be re-generated every time the original dynamic constraint graph changes, but could be used in legacy systems, and could result in very rapid computation times to determine an access result, particularly where the contextual attributes 810 are hashed as a key that can be used to rapidly determine an access result 820.

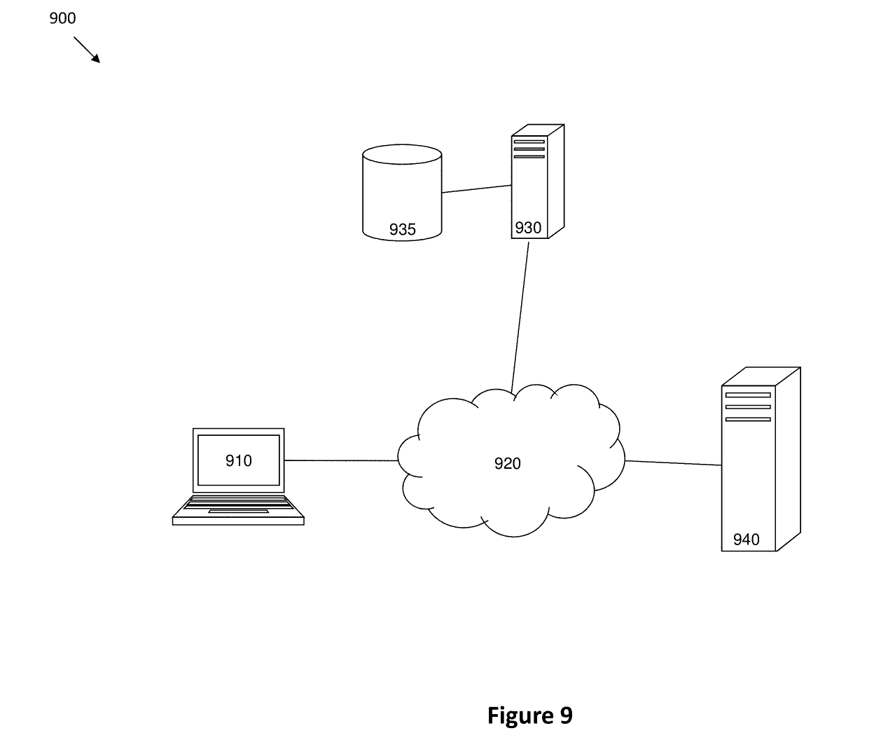

FIG. 9 shows an exemplary hardware schematic 900 having a resource server 930 having resource 935, which communicates with an SBAC system 940 via network 920. User interface 910 requests resources from resource server 930, which then forwards an authorization request, sometimes with local and/or global contextual attributes to SBAC system 940. SBAC system 940 evaluates the authorization request by retrieving an appropriate dynamic constraint graph as a function of one or more portions of the authorization request. The SBAC system 940 could optionally poll user interface 910, resource server 930, or other devices (not shown) via network 920 for additional contextual attributes as a function of the dynamic constraint graph.

For example, the SBAC system could determine that the retrieved dynamic constraint graph requires additional contextual information not provided in the authorization request, and would then initiates a poll to obtain that missing contextual information. SBAC system 940 traverses the dynamic constraint graph as a function of the contextual attributes, and returns an access result to resource server 930, which could then provide scope-based access of its resources 935 to user interface 910 as a function of the access result from SBAC system 940.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for granting fine grain entitlements, comprising:
receiving an authorization request from a resource server comprising a requested resource and a scope;
retrieving a dynamic constraint graph from a catalog as a function of the requested resource and the scope;
receiving a set of local contextual attributes;
traversing the dynamic constraint graph as a function of at least a portion of the set of local contextual attributes to generate an access result;
transmitting an authorization reply transmission as a function of the access result to the resource server.

2. The method of claim 1,
wherein the authorization evaluation request further comprises a plurality of scopes, and
wherein the step of retrieving the dynamic constraint graph further comprises retrieving the dynamic constraint graph as a function of the plurality of scopes and the requested resource.

3. The method of claim 1,
wherein the authorization evaluation request further comprises an action, and
wherein the step of retrieving the dynamic constraint graph further comprises retrieving the dynamic constraint graph as a function of the action, the requested resource, and the scope.

4. The method of claim 1, wherein the dynamic constraint graph comprises nodes of security checks, wherein each node comprises a grant path and a deny path.

5. The method of claim 4, wherein the dynamic constraint graph comprises at least two layers of security checks.

6. The method of claim 4, wherein at least one of the security checks navigates a path as a function of at least one global contextual attribute.

7. The method of claim 6, wherein at least one of the security checks navigates a path as a function of at least one local contextual attribute.

8. The method of claim 1, wherein the reply transmission further comprises an obligation that augments at least one of a grant access result and a deny access result.

9. The method of claim 7, wherein the obligation comprises a time constraint for granting access.

10. The method of claim 7, wherein the obligation comprises an error code for denying access.

11. The method of claim 7, wherein the obligation comprises an alternative resource.

12. The method of claim 7, wherein the obligation comprises an alternative scope.

13. The method of claim 1, further comprising providing a function to the resource server that generates an authorization evaluation request from a submitted set of local contextual attributes and a submitted requested resource.
